(19) United States
(12) Patent Application Publication
(10) Pub. No.: US 2007/0072616 A1
(43) Pub. Date: Mar. 29, 2007

(54) Preventing cellphone usage when driving

(76) Inventor: Cyrus Irani, Houston, TX (US)

Correspondence Address: CYRUS IRANI, 7718 STONESDALE DRIVE, HOUSTON, TX, 77095, US

(21) Appl. No.: 11/233,304

(22) Filed: Sep. 23, 2005

(51) Int. Cl. H04Q 7/20

(52) U.S. Cl. 455/441; 455/456.1

(57) ABSTRACT

A method for preventing cellular phone usage while driving. In one embodiment a GPS system incorporated into the workings of the cellular phone is used to detect that the phone is in motion, and that the rate of movement exceeds some preset value indicating that the phone is in a moving vehicle. Having detected motion the phone will deliver a number of options ranging from complete shutdown until motion stops, to use only for emergency purposes, to only limited use, or to complete use by interjecting a preset PIN or other such password which will allow the cellular phone user to override the phone shutdown mechanism. Other alternate means for detecting motion include triangulation between numerous towers, to signal strength variation from a single tower, to signals generated by miniature accelerometers and velocimeters imbedded in the phone specifically for detecting rate of movement.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates in general to improving the safety of cellular phones. In particular this invention relates to increasing the safety and wellbeing of a cellular phone user if he should be simultaneously driving a vehicle. Specifically, this invention relates to a means for detecting that a cellphone is in motion and then, except for specific situations, curtailing the availability of the cellphone for communication purposes in order to allow the cellphone owner to remain totally focused on the control of the moving vehicle.

2. Background of the Invention

Cellular phones are the fastest growing form of communication. In many parts of the world where the infrastructure for hard lines is minimal, cellular phones have bypassed the need for introducing additional and expensive hard-line infrastructure. Actually, in much of the world the communication norm has shifted away from hard lines to the almost exclusive use of cellular phones. Their portability and convenience of use makes them the ideal replacement for hard line systems, and cellular phones have become so ubiquitous, that it is not at all uncommon in any reasonably sized metropolis to be left with the impression that much of the world has gone mad and is talking animatedly to themselves as they move about their business.

The same features of portability and convenience that make them so ubiquitous can also in certain circumstances make them a hazard. Specifically, for example, a person indulging in a potentially hazardous exercise such as driving a car at high speeds or in congested areas, or working heavy duty machinery, or flying an airplane while also participating in a cellular telephone conversation, can easily become a danger to himself and others around him. Especially if the telephone conversation is of an important or stressful nature which introduces its own measure of distraction. Consequently, an animated or stressful telephone conversation undertaken while participating in an already distracting activity (driving, flying) that requires the cellphone user's full attention is a sure recipe for disaster.

Of all the possible combinations of cellphone usage coinciding with other distracting activity, the combination involving cellphones and cars is the most-prevalent. Even though commonsense would dictate that the driver pull the vehicle over to the side of the road to use the cell phone, human behavior being what it is, this is seldom found to be the case. In actuality, the combination is so fraught with danger and has so repeatedly been implicated in accidents, that many corporations that provide their employees cellphones for business use strictly prohibit the use of the cellphone while driving. Additionally, many states are considering introducing legislation that would bar or at least severely limit the use of cellphones while driving. This lethal combination is so pervasive across all age groups that the state of California is considering banning the use of cellphones by teenagers while driving.

A telling example of this lost functionality is available from a recent report generated by the University of Utah which demonstrates that motorists between the ages of 18 and 25 talking on the cellphone have their driving acumen deteriorate to that of elderly people. Details of the study can be found in the winter (2005) issue of the journal Human Factors, a quarterly publication of the Human Factors and Ergonomics Society. This lost functionality shows up in the cellphone users slowed reaction time and slowed movements, making them more prone to accidents. David Strayer, a University of Utah psychology professor and principal investigator of the study described the transition as “instant aging”, whereby the reaction times of a 20 year old using a cellphone while driving mimicked that of a 70 year old. Because cellphone service providers estimate that 40% or more of their revenues might be generated by. people while driving, they have a financial bias towards discounting such distraction theories. There is even a serious move afoot to create the impression that the hands free mode of cellular communication is safe and that individuals using such a system are not impaired in their driving skills. Unfortunately, this study debunks that myth. The study clearly demonstrates that whether or not the driver's hands are free, the driver's active participation in a phone conversation is sufficient to impair his/her driving ability.

In a damaging indictment, the study further claims that motorists talking on cellphones acted more impaired than drunken drivers with blood-alcohol levels exceeding 0.08. The studies were conducted using a simulator and only hands-free phones that are considered safer were used. Quantitatively, drivers who talked on cellphones were 18% slower in braking and took 17% longer to return to the speeds they were maintaining before they braked. Given that most sizeable metropolitan areas have lengthy rush hour periods, and any inefficiencies during rush hour can significantly impact the commuting time of millions of other commuters, it is only a question of time before data is available to indicate the significant loss of productivity resulting from the slowed response and lost driving acumen demonstrated by individuals using cellphones while driving.

Unfortunately, this problem is only going to get worse as the competition between SERVICE PROVIDERS intensifies, and they start to push more content—like access to the web—onto hand sets. Another typical example of the kinds of distractions that can be expected with the evolution of cell phone service is the planned availability of maps, driving directions, messages on traffic alerts etc. The unfortunate truth of the matter is that SERVICE PROVIDERS make almost 40% of their revenues from people using the cell phone while driving, and consequently have no incentive to limit cell phone usage in spite of the hazards involved. To the contrary, as made clear from the examples cited above, SERVICE PROVIDERS and their counter parts are actively involved with augmenting technologies like Bluetooth to tie in cell phone service with a car's audio system and thus further increase the distracting power of cellphones. Of necessity, these limitations will need to be, and in a number of instances are being, legislated. The problem being that in spite of the laws being passed there has been no technology to allow this legislation to be enforced. Furthermore, in light of the limitations indicated above, it is clear that any solution will need to be inherent to the cell phone itself. Thus it is the intent of this patent to describe an internal paradigm shift in the mechanism by which the phone behaves whereby such laws can be enforced.

There are also liability related motivations to encourage proper cell phone behavior. For example let us consider the case of a hypothetical company/corporation named “Deep Pocket Company/Corporation” (DPC) that has deemed it necessary to provide some or all of its employees with cellphones because the phones are a necessary feature of the employees performing their job function. Let us also presume that for reasons of safety and liability, DPC has mandated that its employees may not use the cellphones while driving. Nonetheless, given human nature, it is entirely feasible that one or a number of DPC employees occasionally or routinely disregard the company's directives and use their company provided cellphone while driving. If any of DPC's employees should be involved in a car accident while also using the cellphone, and as a consequence of the accident, damage to property, or worse, pain, suffering, or even loss of human life results, there is the issue of the liability DPC faces for having provided the errant individual the cellphone which may or may not have been the cause or at least the distraction that led to the accident. It might be easier for DPC to severely limit or outright deny an employee use of the cellphone while driving than to try and address the consequences of some property or personal damage resulting from a car accident that:might be attributable to the employee using the cellphone while driving.

### DEFINITION OF TERMS RELEVANT TO THE PREFERRED EMBODIMENTS

The need to curtail cellphone use while participating in a secondary equally distracting activity such as driving is clearly necessary. Unfortunately, there is at present no effective means for enforcing this curtailment. Consequently, it is the purpose of this invention to provide just such a means for enforcing this curtailment. However, this curtailment has two steps to it, the first step requiring that it be clearly established that the cellphone is in motion preferably in a moving vehicle, with the second step representing some corrective action. Furthermore, the technology and regulatory climate attending cellphones is constantly in flux, and consequently any attempt to resolve this issue must capture the prevailing and anticipated technological changes that are inevitable. Consequently, at least two embodiments of this invention are anticipated, one of which captures the prevailing technology and regulatory climate, and a second that attempts to capture the anticipated changing technical and regulatory climate.

To better understand the embodiments of the invention it might be appropriate to define certain terms necessary to the description of the invention. For example, some aspect of the invention might involve the OWNER of the cellphone. The OWNER of the cellphone is essentially the individual who has purchased the physical cellphone and signed up with the appropriate SERVICE PROVIDER to activate the necessary service that will permit use of the cellphone for communication purposes. In the case of a family, the OWNER would most likely be the head of the household, or any individual adult member of the household, and in all such cases the OWNER would most likely be the individual to whose name the bill is addressed, and who will most likely bear responsibility for the consequences of any inappropriate use of the cellphone. In the case of a business, the OWNER would be the corporate entity that has purchased a single or large number of cellphones with attendant service from a SERVICE PROVIDER for the sole purpose of providing a portable means of communication to one or a multitude of its employees.

On the other hand, the USER of the cellphone could be any individual in possession of the cellphone by legitimate or illegal means, and who is using the cellphone for communication purposes. It is presumed that the cellphone in question has been activated and is enjoying the benefits of a SERVICE PROVIDER'S services so as to make it available for communication purposes. Correspondingly, the SERVICE PROVIDER is any telecommunications entity that is providing a service to the OWNER of the cellphone to facilitate its use as a communications device. In actual practice there would be a PRIMARY SERVICE PROVIDER or the entity with which the owner has his contractual obligation, and which will also be the dominant service provider when the cellphone is in use. However it is recognized that in many instances as when the user is roaming far a field, the cellphone may be out of the range of the communication services provided by the PRIMARY SERVICE PROVIDER, and consequently will be serviced by some SECONDRY SERVICE PROVIDER. Of necessity, the SECONDRY SERVICE PROVIDER will have its own contractual agreement with the PRIMARY SERVICE PROVIDER to accommodate the need for such shared services, and such agreement will be transparent to the OWNER whose only interest is to get the best services possible over the largest territory at the lowest cost.

There is a vast array of physical hardware associated with the use of a cellphone for communication purposes. However, for the purpose of this invention, a significant component would be a TOWER, which is primarily a tall static structure strategically located and which supports receivers and transmitters necessary for facilitating communications with cellphones. In any given geographical region there can be a large number of towers in support of the needs of a specific SERVICE PROVIDER. As the user roams a field it is easy to see where the cellphone services necessary for seamless and continuous communication purposes might shift from those provided by the PRIMARY to some SECONDRY SERVICE PROVIDER as the cellphone moves between the ranges of various towers.

Consequently, an ACTIVE cellphone is one that is being used to initiate or conduct a connection with another telecommunications device. A cellphone that is merely on and in motion is not considered a distraction until such time that it is activated either by the USER or some third party trying to reach the USER for communication purposes. The ACTIVE phase is consequently considered the entire event cycle from such time that the USER has the mental thought to use the cellphone for communication purposes, reaches for the device, activates it, dials in the appropriate instructions, generates a connection, participates in a discussion and then terminates the connection and sets the cellphone down again. Clearly, in a fast moving vehicle under conditions of high traffic density, any one of these steps could prove sufficiently distracting as to contribute to an accident, and consequently are all considered part of the ACTIVE phase of the cellphone usage for communication purposes. Similarly, the reverse process can also prove distracting, namely some third party trying to reach the USER in order to undertake a telephone discussion. In such instances, from the USER's perspective, the distraction starts when the cellphone is activated by the third party's intervention, proceeds through the attempt by the USER to find the phone, turn it on, go through the communication phase, and the turn the phone off and return it to its original location. Consequently, all these events will be captured in the definition of the ACTIVE phase of the cellphone's use.

### PREFERRED EMBODIMENTS OF THE INVENTION

There are a number of preferred embodiments of the invention, all of which require as a first step detection and discerning the true nature of the motion of the cellphone. The present state of cellphone usage technology is such that the principal means for detecting motion would rely entirely on the cellphones internal ability to detect and discern the changing signal strength due to its changing position relative to the strongest source it has located and is exploiting. In conventional applications the source of the signal is a TOWER, and consequently movement of the cellphone is best determined by an analysis of the change in signal strength returned by a TOWER as the phone moves. Another distinguishing feature of the phone's movement that can be exploited would be that the decreasing signal strength returned by one TOWER is compensated by an increasing signal strength returned by some adjacent TOWER as the phone's movement causes a change in its proximity between the two TOWERS.

However, it is entirely feasible that due to some peculiarity of geography or paucity of TOWERS, only one TOWER will remain in range of the cellphone. This could certainly be the case in remote locations away from metropolitan areas of high population density. In this instance, because only one changing signal strength relative to one TOWER is available, a less accurate measure of phone motion might result, and a more significant distance might have to be covered by the phone before a clear indication of movement is discerned. This is a small limitation to the existing technology for determining motion.

Additionally, it is not at all uncommon for many metropolitan areas to have a fairly circular ring road surrounding a city, and if by some coincidence there is only one TOWER to service the entire metropolitan region in question, and if by additional coincidence that TOWER is located at the very center of the circular ring road, it is easy to see where this peculiar set of circumstances could prove detrimental to prompt and convenient detection of cellphone movement if the user is traversing such a ring road. However, it should also be obvious that if the TOWER is even minimally offset from the center, then phone movement by changing signal strength would be feasible much as with the case of a single TOWER in a remote location.

Yet another aspect of the phone's behavior has to be its RESPONSE to detected motion. By RESPONSE in this application is meant the way the phone will behave once a specific type of activity (present in a moving vehicle, for example) is detected. This RESPONSE can either be prompted by instructions imbedded in a new chip installed in the phone specifically for this purpose, or be incorporated into the existing software capability available to the phone's existing hardware, with the final decision being dictated by the most cost effective and implemental practice available.

Another consideration that will significantly impact a cellphone's behavior is the impending requirement that cellphones in the immediate future provide a clear indication of their precise location at such times that an emergency call is placed to say a universal emergency number like 911. This is necessitated by the fact that more often than not, in an emergency situation the USER requesting assistance by cellphone could be sufficiently hurt or disorientated as to provide only a limited or partly coherent description of circumstance and location. Simultaneously, there is ample evidence to substantiate the contention that in a dire emergency every second counts, and the speed with which a severely injured person's trauma can be stabilized by on-the-scene emergency personnel followed by the speed with which the injured person can be brought to a sophisticated hospital can greatly impact the survival odds of the injured party. Consequently, the issue becomes one of locating a disoriented or severely wounded person when a call for emergency assistance is placed. The need for such improved location detection is prompting improvements in the existing ability to pinpoint cellphone location and hastening implementation of next generation technology for further improving the pinpoint accuracy with which a cellphone can be located.

A good example of this next generation technology is the incorporation of Global Positioning Satellite (more commonly known as GPS) technology into cellphones. The use of GPS in cars, boats, airplanes, and by individuals using hand-held devices for position fixing has become so commonplace that no elaboration of the technology is necessary for the elucidation of this patent. Suffice it to say that a cellphone equipped with GPS will be able to deliver information pertinent to its location with pinpoint accuracy. From which it follows that any internal (to the cellphone) interpretative mechanism/software properly calibrated to track the rate of change of position (velocity) of the cellphone will be more than adequate to the task of establishing that the cellphone in question is in motion, and furthermore, that the motion is similar to that which would be observed if the cellphone in question were being conveyed in a car.

Yet another embodiment is available due to the continued evolution of technology and the perpetuation of the myth that hands free driving is safe. Specifically, wireless technology like Bluetooth is being incorporated into the audio system of cars so that cellphone communications can be augmented in a hand's free mode through the car's speakers. As indicated above, such hand's free mode of communication does not result in safer driving habits, and consequently, such variations merely create the impression of a safer driving environment without in the least increasing the safety of the vehicle and its occupants or objects and people surrounding it. However, such technological advances do offer convenient opportunities to exploit the workings of this invention. Thus, for example, it might prove simpler to connect a wireless technology such as Bluetooth through the vehicles speedometer output, such that in the event the speedometer output indicates that the vehicle is in motion above a certain threshold, as discussed below, the wireless device will not allow a phone connection to be made.

Once motion of the phone is established, relating the interpretation of the calculated motion to correspond to a car's movement is simply a case of placing appropriate limits on what the degree of calculated motion signifies The degree of motion, for example, could be used to discern whether the phone is actually moving in a car as opposed to say some other human activity such as walking fast or, jogging or even bicycling. This could be dictated by the setting of a threshold of movement (velocity) as a guideline for some corrective action to be taken. Because using a cellphone even while bicycling can be hazardous, it might be prudent from a safety perspective to set the threshold at some minimal value such as say 5 mph, above which speed the phone would take corrective speed. It needs to be kept in mind that this value of 5 mph is somewhat arbitrary, and for any number of reasons a user of a phone might want to set the value at something different depending on his/her particular needs.

Additionally, it should be clear that as sensing motion (prior to interpretation) is a necessary first step to the workings of this invention, any other method of sensing motion that is presently known or might be eventually created, is also included in the description of this invention. Akin to the GPS case identified above, such motion detection systems might include the use of nanotechnology in the design of miniature accelerometers and velocimeters included in the physical design of the phone, and whose output can also be used to identify whether or not the phone is in motion.

For the purpose of continued discussion of this invention it is now concluded that an adequate means for detecting motion of the phone is available, and furthermore, that this motion can be interpreted as being related to the phone being in a moving vehicle. At this stage, a RESPONSE from the phone is required, and this RESPONSE can be dictated by a number of factors, including but not limited to the following possibilities. Thus, in states where the use of cell phones while driving is illegal, the state might require that the cellphone's RESPONSE should be a termination of service. In this instance one option the phone owner might have would be to isolate the phone from transmitting or receiving any messages during the time it is in motion. For al intents and purposes, while the phone is in motion, the phone will essentially act as though it were dead. During this dead period all incoming calls would be redirected to the phones in-box to be retrieved at such time that the phone establishes that motion has been terminated. In a sense the phone would behave much as it does now if the battery is low or it is in a zone of no service.

On the other hand, the phone OWNER might decide that in order to meet the requirements of the state's laws, phone service be terminated if motion akin to movement in a car is detected. Likewise, owners such as a DPC (see above) that is providing cellphones to employees for business use, but which for financial liability purposes have strict guidelines against using the phone when driving, could direct the phone to terminate service if activated inappropriately. Other similar instances would be in states like California where regulations are under consideration that would prohibit teenagers from using the phone while driving, and where a parent (OWNER) providing a cellphone specifically for a teenager's use (USER) may decide to meet the requirements of the law and prompt a RESPONSE that would terminate service while the phone is in motion.

In reality the choices the USER faces are quite complex and provisions need to be made to ensure that arbitrary actions by the phone do not in their own fashion compromise convenience or worse yet, safety. A good example of a situation where convenience would be compromised would be if two or more teenagers were in the car simultaneously, one as the driver and the others as passengers. Clearly, if all their phones were equipped to respond with a termination of service, then the non-driving teenagers would be inconvenienced because their safety would be only minimally compromised by the use of the cell phone, but nonetheless their service had been terminated.

A more serious situation would arise if the moving vehicle were responding to some emergency where the occupants of the moving vehicle would benefit from continued communication with some other person or agency but were denied the option because of termination of service. Clearly, such a situation would be unacceptable and represents an issue that needs to be fundamentally addressed. Fortunately, there are reasonable resolutions to most of these situations. Thus, for example, the software algorithm controlling the phone's actions can be automatically required to pass through all calls to 911 or 211 or 311 or any of the other emergency numbers commonly used by local safety or emergency agencies, thus eliminating any loss of service under the emergency situation.

In a further embodiment covering the case where the parents of a teenager would always want the teenager to call home first in the event of an emergency, it is feasible that the software algorithm controlling the phone's behavior can be programmed to accept a certain class of pre-set phone numbers as being crucial, and a call to one such number either sent from or received by the moving cellphone will be automatically allowed to go through. On the surface these caveats might seem like a relaxation of the almost stringent need for limiting communication capability of a moving cellphone indicated earlier, but that is not the case. The very ubiquitous presence and usage of cellphones requires that a very pragmatic and judicious approach be taken to define how they should perform so as to optimize their availability for communication purposes without compromising their safety. Certainly it is necessary at all times to keep in mind that the driver of a vehicle has but to pull over to the side of the road to get unfettered cellphone communication access. There are very few situations imaginable where a driver of a vehicle can legitimately claim that it was either unsafe or unfeasible for the driver to pull the vehicle over to the side of the road and use the cellphone in a safe fashion.

The need for such pragmatic approach is best exemplified by the particular requirements of the situation identified earlier where the cellphone USER is a passenger traveling in a moving vehicle. Clearly, the passenger's use of a cellphone in a moving vehicle will have only a minimal impact on the safety of the vehicle. However, a cellphone properly safeguarded according to the teachings of this invention, will not a priori distinguish between whether a driver or a passenger in a moving vehicle is using the phone, but instead will recognize that the phone is in motion and terminate the service. Understandably, this would impose a certain hardship on the passenger's ability to communicate using the cellphone, and it is obvious that some provisions will have to be made to circumvent this limitation. In its simplest embodiment such a by-pass mechanism could take the form of a pass or pin code such that when prompted and inserted, the pass code will cause the phone's software algorithm to completely by-pass the termination protocol.

The beauty of such an approach lies in both its flexibility and the fashion in which it shifts liability. Let us discuss the flexibility element first. Within this context the internal controlling software algorithm can be programmed so as to offer a number of initially preset options that come into play once the override pass code or PIN number is activated. For example, the software algorithm can be set to override the termination code only if a certain pre-selected phone number or set of phone numbers is dialed. Thus a parent can ensure that a teenager either driving or as a passenger in a vehicle can only call home in an unhampered fashion. Another alternative would be to limit the number of calls, namely the software algorithm can be set to allow the cellphone to make one, or five, or some other fixed number of calls once the termination override is activated, following which no additional calls are possible (except to emergency numbers) for some pre-assigned period of time. Yet another alternative would be for the software algorithm to allow only a certain fixed amount of time irrespective of the number of calls made, once the termination override is activated. Clearly, it should be obvious that combinations of the above discussed options should also be feasible.

Addressing the liability issue, let us revert back to the example of the Deep Pocket Corporation (DPC) that has specifically requested its employees to not use the cellphone while driving. In the present circumstance an employee can totally ignore his employer's directives and no issue surfaces unless the employee is involved in a car accident and it can also be shown that the employee was using the cellphone while driving. Under these circumstances, a reasonably apt attorney will be able to transfer some of the responsibility and correspondingly some of the liability for the consequences of the accident back to the employer. However, if the elements of the present invention are in place, the employer has the means to significantly curtail the employees' use of the cell phone while driving and thus limit their liability. The range of restrictions can stretch from termination of service, to just sufficient access as to determine whether the caller and message warrant pulling over and responding to, to using an override code as discussed above for continuous cell usage while driving. In the event that the employee chooses to override the safety measure and continues using the phone while driving, the employee carries a much larger burden of responsibility to show that a situation of sufficient urgency required this override on his part in the event that the employee is involved in a serious accident and a detailed inquiry is initiated.

Table 1, shown below, presents a typical algorithm appropriate to scrutinizing and regulating such an activity. Such an algorithm, which can be readily programmed into a cellphone's operating system, systematically addresses the various options available to the USER when the phone is first activated to ensure that the phone is used in a safe manner. Even though the presented algorithm is appropriate to the task of monitoring and controlling the cellphone's activities, it is by no means unique in this regards. Thus variations in the sequence of actions, or even variations in the nature of the algorithm for achieving this objective, any of which would be obvious to one skilled in the art, are also captured by inclusion in the specifications of this invention.

TABLE 1
INQUIRY
ALGORITHM
Algorithm is automatically accessed when phone is activated to either make or receive a phone call

| ITEM | INQUIRY | RESPONSE | | ACTION | |
|---|---|---|---|---|---|
| 1 | Has phone been activated | YES | NO | If Yes Go To 2 | |
| 2 | Is call to be transmitted | YES | NO | If Yes Go To 3 | If No Go To 50 |
| 3 | Is phone in motion exceeding limits? | YES | NO | If Yes Go To 4 | If No Go To 98 |
| | Is there an absolute no calls in motion | | | | |
| 4 | stipulation? | YES | NO | If Yes go to 100 | If No Go To 5 |
| 5 | Is dialed number an emergency number? | YES | NO | If Yes go to 98 | If No Go To 6 |
| 6 | Is dialed number one of Preset numbers ? | YES | NO | If Yes. Go To 98 | If No Go To 7 |
| 7 | Does protocol allow PIN entry to override termination? | YES | NO | If Yes Go To 8 | If No Go To 100 |
| | Request PIN entry. Start | | | | |
| | timer. Is PIN entry made in | | | | |
| 8 | allowed time? | YES | NO | If Yes Go To 9 | If No Go To 100 |
| 9 | Is PIN entry correct? | YES | NO | If Yes Go To 10 | If No Go To 100 |
| | Does PIN entry offer unlimited access to | | | | |
| 10 | service? | YES | NO | If Yes Go To 98 | If No Go To 11 |
| 11 | Is there a preset time limit for calls in motion? | YES | NO | If Yes Go To 12 | If No Go To 13 |
| 12 | Timer on? | YES | NO | If Yes Go To 98 | If No Go To 100 |
| | Are there a preset number of calls allowed while in | | | | |
| 13 | motion? | YES | NO | If Yes Go To 14 | If No Go To 98 |
| 14 | Counter on? | YES | NO | If Yes Go To 98 | If No Go To 100 |
| 15 | | | | | |
| 16 | | | | | |
| 50 | Is call to be received | YES | NO | If Yes Go To 51 | If No Go To 100 |
| 51 | Is phone in motion exceeding limits? | YES | NO | If Yes Go To 52 | If No Go To 99 |
| | Is there an absolute no calls in motion | | | | |
| 52 | stipulation? | YES | NO | If Yes Go To 100 | If No Go To 53 |
| 53 | Is calling number an emergency number? | YES | NO | If Yes Go To 99 | If No Go To 54 |
| 54 | Is calling number one of Preset numbers ? | YES | NO | If Yes Go To 99 | If No Go To 55 |
| 55 | Does protocol allow PIN entry to override termination? | YES | NO | If Yes Go To 99 | If No Go To 100 |
| | Request PIN entry. Start | | | | |
| | timer. Is PIN entry made in | | | | |
| 56 | allowed time? | YES | NO | If Yes Go To 57 | If No Go To 100 |
| 57 | Is PIN entry correct? | YES | NO | If Yes Go To 58 | If No Go To 100 |
| | Does PIN entry offer unlimited access to | | | | |
| 58 | service? | YES | NO | If Yes Go To 99 | If No Go To 59 |
| 59 | Is there a preset time limit for calls in motion? | YES | NO | If Yes Go To 60 | If No Go To 61 |
| 60 | Timer on? | YES | NO | If Yes Go To 99 | If No Go To 100 |
| | Are there a preset number of calls allowed while in | | | | |
| 61 | motion? | YES | NO | If Yes Go To 62 | If No Go To 99 |
| 62 | Counter on? | YES | NO | If Yes Go To 99 | If No Go To 100 |
| 98 | Transmit call | | | | |
| 99 | Receive call | | | | |
| 100 | Terminate call | | | | |

What is claimed is the capability of a wireless telecom device to send and receive signals when the device is in motion comprising:

A1. A method for detecting motion of the device, comparing the motion against some threshold or pre-assigned rate of movement, and then taking appropriate action to curtail the ability of the device to send or receive communications of a non-crucial nature during the period of motion.

A2. The method of claim A1 wherein the mechanism for detecting movement is based on a Ground Position Satellite (GPS) sensor imbedded in the cellular phone.

A3. The method of claim A1 wherein the movement detected by the GPS sensor is translated into a velocity defining the rate of change of the phone's location as a function of time.

A4. The method of claim of A1 wherein the calculated velocity is compared against some pre-set velocity to determine if the rate of change of the phone's position exceeds this threshold pre-set value.

A5. The method of claim A1 whereby once the determination is made that the phone's velocity exceeds this threshold value, an inquiry algorithm such as is presented in Table 1 is activated.

A6. The method of claim 5 wherein the algorithm will establish whether the phone is to be used for emergency communications and allow the call to go through.

A7. The method of claim 5 wherein the algorithm will establish whether an absolute stipulation against phone usage for non-emergency purposes while driving exists, and shut the phone down.

A8. The method of claim 5 wherein the algorithm will establish whether the phone is attempting to communicate with some preset numbers and allow communications to be established.

A9. The method of claim 5 wherein the algorithm will establish whether a Personal Identification Number (PIN) can be introduced to override the termination protocol.

A10. The method of claim 5 wherein the algorithm will query the cellphone user to enter the appropriate PIN for override purposes.

A11. The method of claim 5 wherein the algorithm will further establish whether the correct PIN was entered in the allocated time period, and either permit or terminate the communication as appropriate.

A12. The method of claim 5 wherein the algorithm will establish whether the override protocol only allows communications for a specified period of time and terminate communications when that time period expires.

A13. The method of claim 5 wherein the algorithm will establish whether the override protocol only allows communications for a specified number of calls, and termination communications when that number is exceeded.

A14. The method of claim 5 wherein the algorithm will establish whether any other limitations are present before establishing communications when the phone is in motion.

A15. The method of claim A1 wherein the mechanism for detecting movement is based on a triangulation method imbedded in the cellular phone whereby the movement of the cellphone is detected by the act of triangulating the cell phones signal strength between at least two and preferably more towers as the phone changes location.

A16. The method of claim A1 wherein the movement detected by the triangulation method is translated into a velocity defining the rate of change of the phone's location as a function of time.

A17. The method of claim of A1 wherein the calculated velocity is compared against some pre-set velocity to determine if the rate of change of the phone's position exceeds this threshold pre-set value.

A18. The method of claim A1 wherein the mechanism for detecting motion is based on an analysis of signal strength form a single tower due to the phone's remote location.

A19. The method of claim A1 wherein the mechanism for detecting motion is based on an analysis of signals generated by miniaturized velocimeters and accelerometers imbedded in the cellphone's body for the specific purpose of detecting motion.

A20. The method of claim A1 wherein the mechanism for detecting motion is based on an analysis of signals generated by some notechnology paradigm specifically designed for this purpose.
